(19) United States
(12) Patent Application Publication
(10) Pub. No.: US 2011/0224086 A1
(43) Pub. Date: Sep. 15, 2011

(54) Methods and Algorithms for Selecting Polynucleotides For Synthetic Assembly

(76) Inventors: Jose Pardinas, San Diego, CA (US); Shanrong Zhao, San Diego, CA (US)

(21) Appl. No.: 12/720,060

(22) Filed: Mar. 9, 2010

(51) Int. Cl. C40B 20/00; C40B 50/04; C40B 30/00

(52) U.S. Cl. 506/2; 506/25; 506/7

(57) ABSTRACT

The present invention relates to methods and algorithms for identifying, synthesizing and co-assembling combinatorial libraries of polynucleotide variants.

### FIELD OF THE INVENTION

The present invention relates to methods and algorithms for identifying, synthesizing and co-assembling combinatorial libraries of polynucleotide variants.

### BACKGROUND OF THE INVENTION

The present invention relates generally to the area of bioinformatics and more specifically to methods and algorithms for computer-aided selection and subsequent synthesis of combinatorial libraries of polynucleotide variants.

Development of biopharmaceuticals requires substantial effort around screening, generation and characterization of variants of the proposed therapeutic as well as required research reagents to identify the best candidates demonstrating appropriate biochemical and biophysical properties. Variants are typically selected from expression libraries generated using random or site-directed PCR-based mutagenesis methods (Kunkel, Proc. Natl. Acad. Sci. USA, 82:488-92, 1985; Weiner et al., Gene, 151:119-23, 1994; Ishii et al., Methods Enzymol., 293:53-71, 1988).

An alternative to PCR-based methods to generate variants is synthetic polynucleotide assembly as described in e.g. U.S. Pat. No. 6,521,427 and U.S. Pat. No. 6,670,127). Synthetic polynucleotide assembly allows cost-effective generation of difficult-to-clone genes, functional or codon-optimized variants for activity studies and protein production, and bypasses sometimes tedious and lengthy mutagenesis and subcloning protocols (Xiong et al., FEMS Microbiol. Rev. 32:522-540, 2008).

Both PCR-based and synthetic polynucleotide assembly methods suffer from their inability to generate libraries of predefined variants without generating additional variation within the variant pool due to the annealing dynamics of the DNA. A need often exists to generate a library of polynucleotide variants having predefined variation, such as the human framework libraries designed for antibody humanization, or computer-aided designed libraries for antibody affinity maturation. Thus, there is a need for methods and algorithms to facilitate synthesis of libraries of predefined variants without generating de novo variation within the preselected variant pool.

### SUMMARY OF THE INVENTION

One aspect of the invention is a method of identifying a combinatorial library of polynucleotide variants, comprising:
a. providing a collection of polynucleotide variants;
b. obtaining sequences of the polynucleotide variants;
c. parsing the polynucleotide variants into contiguous parsed oligonucleotides;
d. adding a first polynucleotide variant from the collection of polynucleotide variants into the combinatorial library;
e. comparing corresponding parsed oligonucleotides in the first polynucleotide variant and the collection of polynucleotide variants;
f. adding those polynucleotide variants from the collection of polynucleotide variants into an analyzed pool of polynucleotide variants that differ at only one corresponding parsed oligonucleotide from the first polynucleotide variant;
g. adding a second polynucleotide variant from the analyzed pool of polynucleotide variants into the combinatorial library;
h. comparing corresponding parsed oligonucleotides in the second polynucleotide variant and the collection of polynucleotide variants;
i. adding those polynucleotide variants from the collection of polynucleotide variants into the analyzed pool of polynucleotide variants that differ at only one corresponding parsed oligonucleotide from the second polynucleotide variant; and
j. repeating steps g-i until the analyzed pool of polynucleotide variants is empty.

Another aspect of the invention is a method of synthesizing a combinatorial library of polynucleotide variants, comprising:
a. providing a collection of polynucleotide variants;
b. obtaining sequences of the polynucleotide variants;
c. parsing the polynucleotide variants into contiguous parsed oligonucleotides;
d. adding a first polynucleotide variant from the collection of polynucleotide variants into the combinatorial library;
e. comparing corresponding parsed oligonucleotides in the first polynucleotide variant and the collection of polynucleotide variants;
f. adding those polynucleotide variants from the collection of polynucleotide variants into an analyzed pool of polynucleotide variants that differ at only one corresponding parsed oligonucleotide from the first polynucleotide variant;
g. adding a second polynucleotide variant from the analyzed pool of polynucleotide variants into the combinatorial library;
h. comparing corresponding parsed oligonucleotides in the second polynucleotide variant and the collection of polynucleotide variants;
i. adding those polynucleotide variants from the collection of polynucleotide variants into the analyzed pool of polynucleotide variants that differ at only one corresponding parsed oligonucleotide from the second polynucleotide variant;
j. repeating steps g-i until the analyzed pool of polynucleotide variants is empty, and
k. synthesizing the combinatorial library of polynucleotide variants using synthetic polynucleotide assembly.

Another aspect of the invention is a method of selecting combinatorial libraries that can form a co-assembly set, comprising:
a. identifying a first and a second combinatorial library according to methods of the invention
b. parsing each sequence in the first and the second combinatorial library into contiguous oligonucleotides;
c. comparing a first pool of corresponding parsed oligonucleotides in the first library and a second pool of corresponding parsed oligonucleotides in the second library; and
d. selecting the first and the second combinatorial library when the first pool of corresponding parsed oligonucleotides and the second pool of corresponding parsed oligonucleotides share zero identical sequences at one or more adjacent corresponding fragments.

### BRIEF DESCRIPTION OF THE DRAWINGS

FIG. 1. shows the concept of the annealing process and co-assembly during synthetic polynucleotide assembly.

FIG. 2. illustrates the key concept of forming co-assembly sets.

FIG. 3. shows the flowchart for identifying co-assembly sets

FIG. 4. shows a combinatorial sibling matrix.

### DETAILED DESCRIPTION OF THE INVENTION

All publications, including but not limited to patents and patent applications, cited in this specification are herein incorporated by reference as though fully set forth.

As used herein and in the claims, the singular forms “a,” “and,” and “the” include plural reference unless the context clearly dictates otherwise. Thus, for example, reference to “a polypeptide” is a reference to one or more polypeptides and includes equivalents thereof known to those skilled in the art.

Unless defined otherwise, all technical and scientific terms used herein have the same meaning as commonly understood by one of ordinary skill in the art to which an invention belongs. Although any compositions and methods similar or equivalent to those described herein can be used in the practice or testing of the invention, exemplary compositions and methods are described herein.

The term “combinatorial library” as used herein refers to a library of sequences of polynucleotide variants wherein for each sequence in the combinatorial library there is at least one other sequence present in the library that differs at only one corresponding parsed oligonucleotide; and (2) the number of sequences in the combinatorial library is equal to the number of unique sequences obtained by synthetic polynucleotide assembly by pooling together all parsed oligonucleotides having unique sequences. A combinatorial library can include one or more variants of a polynucleotide. A combinatorial library can include, 1×10¹, 1×10², 1×10³, 1×10⁴, 1×10⁵ variants.

The term “synthetic polynucleotide assembly” as used herein refers to the method of chemical synthesis of polynucleotides as described in U.S. Pat. No. 6,521,427 and U.S. Pat. No. 6,670,127, which are herein incorporated by reference.

The term “polynucleotide” as used herein means a molecule comprising a chain of nucleotides covalently linked by a sugar-phosphate backbone or other equivalent covalent chemistry. Double and single-stranded DNAs and RNAs are typical examples of polynucleotides. The polynucleotides can be 100, 200, 300, 400, 800, 1000, 1500, 2000, 4000, 8000, 10000, 12000, 18,000, 20,000, 40,000, 80,000 or more base pairs in length, and can be non-naturally occurring or can originate from bacterial, yeast, viral, mammalian, amphibian, reptilian, or avian genomes. The polynucleotide can include coding regions or non-coding elements such as origins of replication, telomeres, promoters, enhancers, transcription and translation start and stop signals, introns, exon splice sites, chromatin scaffold components and other regulatory sequences

Short polynucleotides are referred to as “oligonucleotides”. Oligonucleotides can be of various lengths, typically more than two base pairs in length. The exact size of an oligonucleotide depends on many factors, such as the reaction temperature, salt concentration, the presence of denaturants such as formamide, and the degree of complementarity with the sequence to which the oligonucleotide is intended to hybridize. The oligonucleotides can be about 15-150 bases, between about 20-100 bases, between about 25-75 bases, or between about 30-50 bases long. Exemplary oligonucleotides are 24 or 48 bases in length.

The term “variant” as used herein refers to a polynucleotide or oligonucleotide that differs from a reference “wild type” polynucleotide and may or may not retain essential properties. Generally, differences in sequences of the wild type polynucleotide and the variant are closely similar overall and, in many regions, identical. A variant may differ from the wild type polynucleotide in its sequence by one or more modifications for example, substitutions, insertions or deletions of nucleotides. A substituted or inserted nucleotide may result in stop, no change, in conservative or non-conservative substitution in the codon the nucleotide encodes. A variant of a polynucleotide may be naturally occurring or synthetic, and may have 50%, 55%, 60%, 65%, 70%, 75%, 80%, 85%, 90%, 95%, 96%, 97%, 98%, or 99% identity with the wild type polynucleotide. Nucleotides present in the variant polynucleotides include modified bases capable of base pairing with adenine, cytosine, guanine, thymine and uracil. Exemplary modified bases include 8-azaguanine and hypoxanthine.

It is possible to modify the structure or function of the polypeptides encoded by variant polynucleotide sequences for such purposes as enhancing activity, specificity, stability, solubility, and the like. A replacement of a codon encoding leucine with codons encoding isoleucine or valine, a codon encoding an aspartate with a codon encoding glutamate, a codon encoding threonine with a codon encoding serine, or a similar replacement of codons encoding structurally related amino acids (i.e., conservative mutations) will, in some instances but not all, not have a major effect on the biological activity of the resulting molecule. Conservative replacements are those that take place within a family of amino acids that are related in their side chains. Genetically encoded amino acids can be divided into four families: (1) acidic (aspartate, glutamate); (2) basic (lysine, arginine, histidine); (3) nonpolar (alanine, valine, leucine, isoleucine, proline, phenylalanine, methionine, tryptophan); and (4) uncharged polar (glycine, asparagine, glutamine, cysteine, serine, threonine, tyrosine). Phenylalanine, tryptophan, and tyrosine are sometimes classified jointly as aromatic amino acids. In similar fashion, the amino acid repertoire can be grouped as (1) acidic (aspartate, glutamate); (2) basic (lysine, arginine histidine), (3) aliphatic (glycine, alanine, valine, leucine, isoleucine, serine, threonine), with serine and threonine optionally be grouped separately as aliphatic-hydroxyl; (4) aromatic (phenylalanine, tyrosine, tryptophan); (5) amide (asparagine, glutamine); and (6) sulfur-containing (cysteine and methionine) (Stryer (ed.), Biochemistry, 2nd ed, WH Freeman and Co., 1981). Whether a change in the amino acid sequence of a polypeptide or fragment thereof encoded by a variant polynucleotide results in a functional homolog can be readily determined by assessing the ability of the modified polypeptide or fragment to produce a response in a fashion similar to the unmodified polypeptide or fragment using the assays described herein. Peptides, polypeptides or proteins in which more than one replacement has taken place can readily be tested in the same manner.

The term “wild type” or “WT” refers to a polynucleotide that has the characteristics of that polynucleotide when isolated from a naturally occurring source. An exemplary wild type polynucleotide is a polynucleotide encoding a gene that is most frequently observed in a population and is thus arbitrarily designated the “normal” or “reference” or “wild type” form.

A polynucleotide sequence can be designed in a computer-assisted manner and used to generate a set of parsed oligonucleotides covering the plus (+) (e.g. forward) and minus (−) (e.g. reverse) strand of the sequence. As used herein, the term “parsed” means that a sequence of a polynucleotide variant has been delineated in a computer-assisted manner such that a series of contiguous oligonucleotide sequences are identified. The oligonucleotide sequences are individually synthesized and used in the methods of the invention to design algorithms for appropriate pooling of the polynucleotides and to synthesize identified combinatorial libraries and co-assembly sets. Parsing and subsequent polynucleotide synthesis is done according to methods described in U.S. Pat. No. 6,521,427 and U.S. Pat. No. 6,670,127, which are herein incorporated by reference. Methods of synthesizing oligonucleotides are found in, for example, in: Oligonucleotide Synthesis: A Practical Approach, Gate, ed., IRL Press, Oxford (1984).

“Contiguous parsed oligonucleotides”, as used herein refers to two oligonucleotides wherein the first oligonucleotide ends at position arbitarily set at −1 and the second fragment starts at position arbitarily set at 0 along the linear polynucleotide sequence. Fragments can be of varying length, for example 16-32 nucleotides.

“Corresponding parsed oligonucleotides” as used herein refers to oligonucleotides that start and end at identical positions along the polynucleotide sequence between two or more polynucleotide sequences. Corresponding parsed oligonucleotides can have an identical sequence or they can represent polynucleotide variants as described above.

“Pool of corresponding parsed oligonucleotides” as used herein refers to more than one corresponding parsed oligonucleotide present in one combinatorial library.

“Analyzed pool” as used herein refers to the pool of polynucleotide variants that have been identified as part of a combinatorial library, and are further tested against additional polynucleotide sequences to identify additional sequences forming the combinatorial library.

The term “co-assembly set” as used herein refers to a library of polynucleotide variants that can be synthesized by synthetic polynucleotide assembly in one pool without synthesizing additional variants with unique polynucleotide sequences during the annealing reactions. The term “co-assembled” refers to library of polynucleotide variants that can form a co-assembly set.

The term “assembly in one pool” or “annealed in one pool” as used herein refers to synthesis of a library of polynucleotides using synthetic polynucleotide assembly and annealing all parsed oligonucleotides in one reaction mixture.

The term “complementary sequence” as used herein refers to a second isolated polynucleotide sequence that is antiparallel to a first isolated polynucleotide sequence and that comprises nucleotides complementary to the nucleotides in the first polynucleotide sequence. Typically, such “complementary sequences” are capable of forming a double-stranded polynucleotide molecule such as double-stranded DNA or double-stranded RNA when combined under appropriate conditions with the first isolated polynucleotide sequence.

The term “vector” means a polynucleotide capable of being duplicated within a biological system or that can be moved between such systems. Vector polynucleotides typically contain elements, such as origins of replication, polyadenylation signal or selection markers, that function to facilitate the duplication or maintenance of these polynucleotides in a biological system. Examples of such biological systems may include a cell, virus, animal, plant, and reconstituted biological systems utilizing biological components capable of duplicating a vector. The polynucleotides comprising a vector may be DNA or RNA molecules or hybrids of these.

The term “expression vector” means a vector that can be utilized in a biological system or a reconstituted biological system to direct the translation of a polypeptide encoded by a polynucleotide sequence present in the expression vector.

The term “polypeptide” means a molecule that comprises at least two amino acid residues linked by a peptide bond to form a polypeptide. Small polypeptides of less than 50 amino acids may be referred to as “peptides”. Polypeptides may also be referred to as “proteins.”

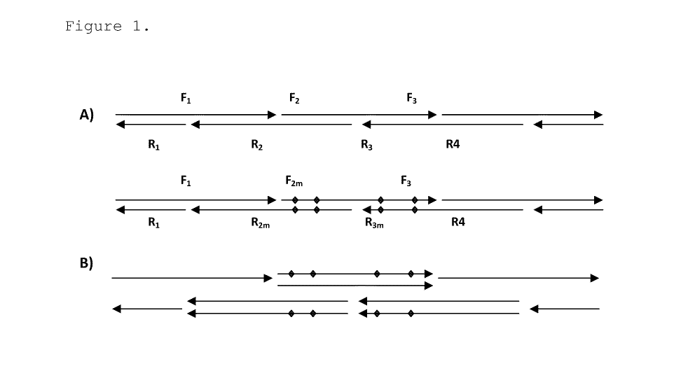

Synthetic polynucleotide assembly has many attractive features including the possibility of preparing, without any significant limitations, any desirable gene sequence. Synthetic polynucleotide assembly consists of two stages: (1) parsing a polynucleotide sequence into forward (F) and reverse (R) oligonucleotide fragments and synthesizing the oligonucleotides; and (2) assembling the synthesized oligonucleotides to generate the desired polynucleotides. During the assembly stage, all forward and reverse oligonucleotides are annealed in one pool, and the nicks are repaired with ligase (U.S. Pat. No. 6,521,427 and U.S. Pat. No. 6,670,127). Because of annealing properties of the polynucleotides, only oligonucleotides having complementary sequences will anneal with each other (FIG. 1A). While the synthetic polynucleotide assembly is exceptionally robust, it is less optimal when libraries of polynucleotide variants need to be synthesized. For example, to synthesize a library of 100 polynucleotide variants, 100 individual synthetic polynucleotide assembly reactions would be needed.

The present invention relates to methods and algorithms of identifying and synthesizing combinatorial libraries and co-assembly sets of polynucleotide variants using synthetic polynucleotide assembly without generating de novo variation within the polynucleotide variant pool due to mis-annealing of used oligonucleotides. The invention is useful in various applications that require screening, generation and characterization of libraries of polynucleotide variants. Exemplary applications are generation of libraries of antibody variable regions or libraries of other therapeutic protein variants.

FIG. 1A shows the concept of the annealing process for a double stranded polynucleotide during synthetic polynucleotide assembly. Variant 1 (in the top in FIG. 1A) and Variant 2 (in the bottom in FIG. 1A) are parsed into 3 forward and 4 reverse oligonucleotides each (F₁, F₂, F₃ and R₁, R₂, R₃, and R₄ for Variant 1, F₁, F₂ₘ, F₃ and R₁, R₂ₘ, R₃ₘ, and R₄ for Variant 2). The two variants differ in their sequence at corresponding parsed oligonucleotides F₂ and F₂ₙ (and the complementary oligonucleotides R₂ R₂ₘ, R₃ and R₃ₘ). When all parsed olignucleotides for Variant 1 and Variant 2 with unique sequences are pooled together (e.g., F₁, F₂, F₂ₘ, F₃ R₁, R₂, R₂ₘ, R₃, R₃ₘ, and R₄), only the original Variants 1 and 2 are being synthesized. Due to the annealing properties of nucleotides, the mis-paired complementary oligonucleotides F2 and R₂ₘ, F2 and R₃ₘ, F₂ₘ and R₂, and R₂ₘ, F₂ will not anneal with each other. Thus, the corresponding parsed oligonucleoides for variants 1 and 2 can be pooled together for synthetic polynucleotide assembly, and the assembly process will result in the synthesis of the exact variants 1 and 2 without generating additional variants with unique sequences. Thus, the variant 1 and 2 are a co-assembly set.

The concept of polynucleotide co-assembly can be applied to any collection of polynucleotide variants whose sequences differ at corresponding parsed oligonucleotides. However, not any collection of polynucleotide variants can be co-assembled. The computational algorithms developed in the present invention are designed to identify those polynucleotide variants that can form a co-assembly set.

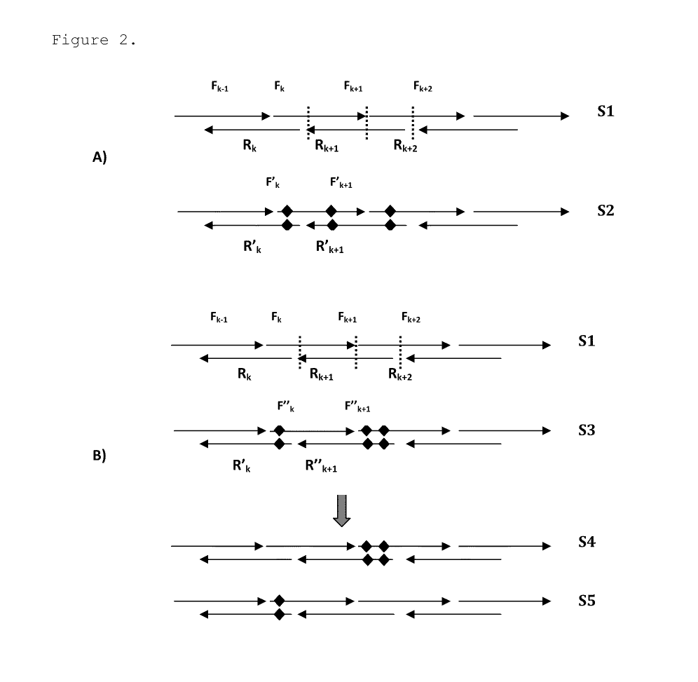

The requirement for co-assembly of any two polynucleotides is that each forward and reverse oligonucleotide hybridize with each other only when the region of complementarity between the sequences demonstrates 100% identity. Otherwise, mis-pairing will occur and new variants will be generated during the annealing process (FIG. 2).

The example in FIG. 2A shows that the two variants S1 and S2 can form a co-assembly set as the S1 forward parsed oligonucleotide Fₖ can only hybridize with the parsed oligonucleotides Rₖ and Rₖ₊₁, which are 100% complementary over the region of their overlap with Fₖ. After pooling and synthetic polynucleotide assembly of parsed oligonucleotides with unique sequences, only the two variants S1 and S2 are synthesized.

The example in FIG. 2B shows that the two variants S1 and S3 cannot form a co-assembly set. The forward parsed olignucleotide Fₖ can hybridize with either Rₖ₊₁ for S1 or R″ₖ₊₁ for S3. Likewise, the forward parsed oligonucleotide F″ₖ can hybridize with either Rₖ₊₁ for S1 or R″ₖ₊₁ for S3. As a result, after pooling and synthetic polynucleotide assembly of parsed oligonucleotides with unique sequences, additional variants S4 and S5 will be synthesized as well. S4 is synthesized as a result of annealing of Fₖ and R″ₖ₊₁ and S5 is synthesized as a result of annealing of F″ₖ and Rₖ₊₁.

Since the complementary nature of double stranded DNA, only forward parsed oligonucleotides are required for analysis when determining which polynucleotides can form a co-assembly set. The obligatory and sufficient condition for two polynucleotides to form a co-assembly set is that the polynucleotides have contigous forward parsed oligonucleotides that are non-identical in sequence at each half-oligonucleotide length.

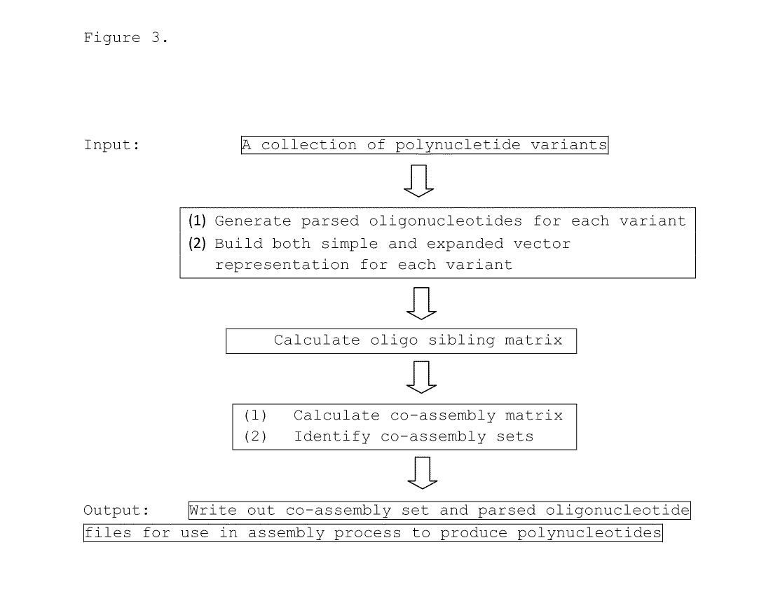

The example in FIG. 2B also illustrates that a combinatorial library of polynucleotide variants can be co-assembled. The variants S1, S3, S4 and S5 form a combinatorial library, and thus can be synthesized using synthetic polynucleotide assembly in one pool. The flowchart for identifying co-assembly sets is conceptually outlined in FIG. 3.

One aspect of the invention is a method of identifying a combinatorial library of polynucleotide variants, comprising
a. providing a collection of polynucleotide variants;
b. obtaining sequences of the polynucleotide variants;
c. parsing the polynucleotide variants into contiguous parsed oligonucleotides;
d. adding a first polynucleotide variant from the collection of polynucleotide variants into the combinatorial library;
e. comparing corresponding parsed oligonucleotides in the first polynucleotide variant and the collection of polynucleotide variants;
f. adding those polynucleotide variants from the collection of polynucleotide variants into an analyzed pool of polynucleotide variants that differ at only one corresponding parsed oligonucleotide from the first polynucleotide variant;
g. adding a second polynucleotide variant from the analyzed pool of polynucleotide variants into the combinatorial library;
h. comparing corresponding parsed oligonucleotides in the second polynucleotide variant and the collection of polynucleotide variants;
i. adding those polynucleotide variants from the collection of polynucleotide variants into the analyzed pool of polynucleotide variants that differ at only one corresponding parsed oligonucleotide from the second polynucleotide variant; and
j. repeating steps g-i until the analyzed pool of polynucleotide variants is empty.

The parsed oligonucleotides are defined as numerical vectors in the mathematical algorithms. Each polynucleotide variant in the collection of variants is parsed into contigous oligonucleotides of M bases long. A unique number is assigned to each corresponding parsed oligonucleotide having a unique sequence within the collection of polynucleotides being analyzed. A parsed polynucleotide variant can be presented as a simple vector representation as shown below:

{F₁, F₂, F₃, . . . Fᵢ, . . . Fₙ},

Wherein F1=the first corresponding parsed oligonucleotide

Fi=the ith corresponding parsed oligonucleotide
Fn=the last corresponding parsed oligonucleotide

Alternatively, a parsed polynucleotide variant can be presented as an expanded vector representation by dividing each original parsed oligonucleotide into two contiguous half-oligonucleotides of M/2 bases long. A unique number is again assigned to each corresponding parsed half oligonucleotide having a unique sequence within the collection of polynculeotides being analyzed. The expanded vector representation of a polynucleotide variant is shown below:

{F₁₋₁, F₁₋₂, F₂₋₁, F₂₋₂, F₃₋₁, F₃₋₂, . . . , Fᵢ₋₁, Fᵢ₋₂, . . . , Fₙ₋₁, Fₙ₋₂}

Wherein F₁₋₁=the 1^{st} half-oligonucleotides in the first corresponding parsed oligonucleotide

F₁₋₂=the 2^{nd} half-oligonucleotides in the first corresponding parsed oligonucleotide

Fᵢ₋₁=the 1^{st} half-oligonucleotides in the ith corresponding parsed oligonucleotide

Fᵢ₋₂=the 2^{nd} half-oligonucleotides in the ith corresponding parsed oligonucleotide

Fₙ₋₁=the 1^{st} half-oligonucleotides in the last corresponding parsed oligonucleotide

Fₙ₋₂=the 2^{nd} half-oligonucleotides in the last corresponding parsed oligonucleotide

The simple vector representation is typically used to identify polynucleotide variants that constitute a combinatorial library, and the expanded vector representation to identify two groups of polynucleotide variants that can be co-assembled.

Oligonucleotide sibling matrix is constructed that is utilized in subsequent analyses to identify polynucleotide variants that form a combinatorial library. Two genes are considered as siblings if they differ at only one corresponding parsed oligonucleotide. For a library consisting of N polynucleotide variants, its corresponding oligonucleotide sibling matrix is of the size N*N, and each matrix element Mᵢⱼ in the matrix is defined below:

$${M}_{ij} = {V}_{i} Δ {V}_{j} = \{ \begin{matrix}oligoFragNo , when {S}_{i} , {S}_{j} differs only \\ at fragment oligoFragNo\end{matrix}$$

wherein
l<=oligoFragNo<=n,
n=number of oligo fragments required for a gene assembly
Vᵢ and Vⱼ are two oligonucleotide vectors for polynucleotide variants Sᵢ and Sⱼ respectively.

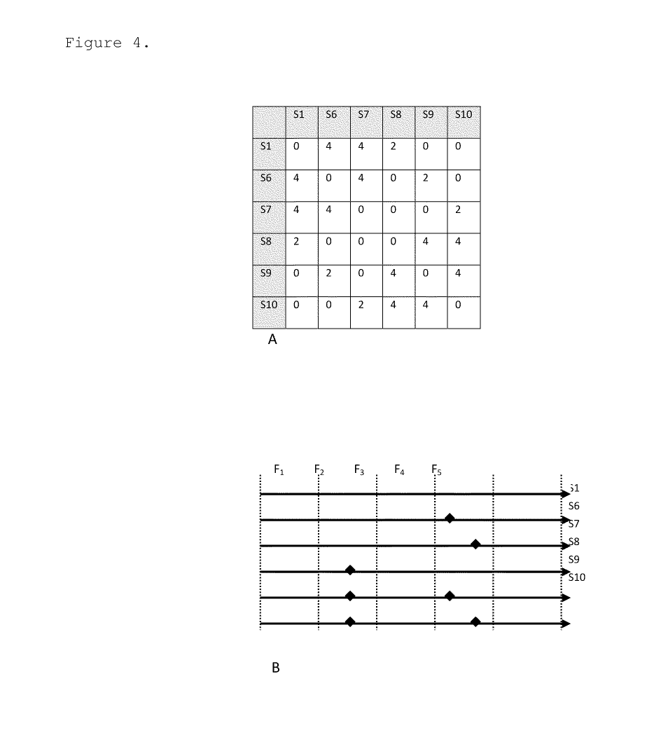

An exemplary symmetrical oligonucleotide sibling matrix is shown in FIG. 4A for the six polynucleotide variants shown as vector representation in FIG. 4B. In FIG. 4B, the six variants differ at 2^{nd} (with 2 unique oligonucleotides at F2 position) and 4^{th} parsed corresponding oligonucleotides (with 3 unique oligonucleotides at F4 position). The reverse oligonucleotides are not shown. The variants S1 and S6 differ only at the F4 oligonucleotide, and accordingly, matrix cell M_{1,2}=4 in FIG. 4A. In contrast, S1 and S5 differ at both F2 and F4 parsed oligonucleotide, and thus, the matrix cell M_{1.5}=0.

A combinatorial library can be identified from the oligonucleotide sibling matrix by recursively finding new sibling polynucleotide variants starting from a seed polynucleotide variant. For example, a first seed polynucleotide variant can be set to S1. The sibling matrix is scanned along the row for S1, and sibling polynucleotide variants S6, S7 and S8 are added to the combinatorial library. Subsequently, matrix rows corresponding to S6, S7 and S8 are scanned for new sibling polynucleotide variants. Polynucleotide variant S9 is identified when the matrix is scanned for row corresponding to S6, and the variant S10 is identified during scanning for row corresponding to S7. The identified siblings are added to the combinatorial library. For the variant collection in FIG. 4B, only two rounds of scanning are needed to identify the variants that form a combinatorial library. ALGORITHM 1 provides a method for identifying polynucleotide variant sequences that form a combinatorial library from a collection of variant sequences:

Key parameters in the algorithm:

| | |
|---|---|
| S_{seed}: | starting seed sequence |
| C_{lib}: | combinatorial library; |
| N: | total number of polynucleotide variants to be |
| analyzed | |
| Vₗᵢₛₜ: | list of genes to be visited |

```
  1) Initialization. empty -> Vₗᵢₛₜ, empty -> C_{lib};
  2) Choose a seed sequence S_{seed};
  3) Add S_{seed}=> C_{lib};
  4) Scan matrix row corresponding to S_{seed}
    For (every variants to be analyzed) {
      If ( M_{seed},ⱼ not equal 0 ) {
        If (Variant Sⱼ is neither in C_{lib} nor in Vₗᵢₛₜ)
          Add Sⱼ to Vₗᵢₛₜ
        }
      }
  5) If (Vₗᵢₛₜ is empty) stop and output C_{lib};
      Else {
        Set S_{seed} to the first sequence in Vₗᵢₛₜ
        Go to step 3
      }
```

Sequences of the polynucleotide variants can be obtained using standard sequencing methods or can be downloaded from public databases. For example, sequences of human antibody germline genes can be downloaded from the ImMunoGeneTics DataBase (imgt cines fr). Variants of the human frameworks can be designed by altering residues at positions that may preserve or enhance binding affinity during humanization, such as positions described in U.S. Pat. No. 6,402,213. Rational design can be employed to design variants anticipated to have specific effect on structure or activity of the potential therapeutic proteins.

The obtained sequences of the polynucleotide variants are parsed according to methods described in U.S. Pat. No. 6,521,427.

Another aspect of the invention is a method of selecting combinatorial libraries that can form a co-assembly set, comprising:
a. identifying a first and a second combinatorial library according to methods of the invention
b. parsing each sequence in the first and the second combinatorial library into contiguous oligonucleotides;
c. comparing a first pool of corresponding parsed oligonucleotides in the first library and a second pool of corresponding parsed oligonucleotides in the second library; and
d. selecting the first and the second combinatorial library when the first pool of corresponding parsed oligonucleotides and the second pool of corresponding parsed oligonucleotides share zero identical sequences at one or more adjacent corresponding fragments

For identifying libraries that can be co-assembled, the expanded vector representation of polynucleotide variants is used.

The obligatory and sufficient condition for two polynucleotides to form a co-assembly set is that the polynucleotides have contigous forward parsed oligonucleotides that are non-identical in sequence at each half-oligonucleotide length. The rule is implemented by introducing a specific XOR operation among expanded vector representations for the two variants as below:
Vᵢ: {F₁₋₁, F₁₋₂, F₂₋₁, F₂₋₂, . . . , Fₖ₋₁, Fₖ₋₂, . . . , Fₙ₋₂, Fₙ₋₂}
Vⱼ: {F′₁₋₁, F′₁₋₂, F′₂₋₁, F′₂₋₂, . . . , F′ₖ₋₁, F′ₖ₋₂, . . . , F′ₙ₋₂, F′ₙ₋₂, F′ₙ₋₂}
Vᵢ⊕Vⱼ={F₁₋₁⊕F′₁₋₁, F₁₋₂⊕F′₂₋₂, . . . , Fₖ₋₁⊕F′ₖ₋₁, Fₖ₋₂⊕F′ₖ₋₂, . . . Fₙ₋₁⊕F′Fₙ₋₂⊕F′ₙ₋₂}

wherein

Vᵢ and Vⱼ are expanded vector representations for sequence Si and Sj.

The meaning of F₁₋₁, F₁₋₂ . . . Fᵢ₋₁, Fᵢ₋₂ . . . Fₙ₋₁, Fₙ₋₂ is same as above (page 12)
F′₁₋₁, F′_{1-2 . . . F′}ᵢ₋₁, F′_{1-2 . . . F′}ₙ₋₁, F′ₙ₋₂ have similar definition as F₁₋₁, F₁₋₂ . . . Fᵢ₋₁, Fᵢ₋₂ . . . Fₙ₋₁, Fₙ₋₂. Instead of F, F′ is used to denonate a different sequence.
wherein
Fₖ₋ₕ⊕F′ₖ₋ₕ=0, when Fₖ₋ₕ==F′ₖ₋ₕ (where 1<=k<=n, and h=1 or h=2); otherwise, Fₖ₋ₕ⊕F′ₖ₋ₕ=1, meaning the two forward parsed oligonucleotides are non-identical in sequence at the analyzed half-oligonucleotide.
   If the result vector from the XOR operation contains only one strip of “1”s, the two polynucleotides can be co-assembled. For instance, the expanded vectors for the two polynucleotide variants in FIG. 1A. and 1B. are {1,1,1,1,1,1} and {1,1,2,2,1,1} respectively, and the result vector for XOR operation is {0,0,1,1,0,0}. These two genes can form a co-assembly set since there are two continuous “1”s in the result vector, and thus mis-annealing of parsed olignucleotides does of occur during pooled synthesis of the variants.

The XOR operation is applied to identify if two combinatorial libraries form a co-assembly set. The format of expanded vector representation for combinatorial libraries is very similar to the one for a two polynucleotides except for the presence of multiple variants of half-oligonucleotides at corresponding positions.
Vᵢ_{_{—}}_{lib}: {ΣF₁₋₁, ΣF₁₋₂, ΣF₂₋₁, ΣF₂₋₂, ΣF₃₋₁, . . . ΣFₖ₋₁, ΣFₖ₋₂, . . . ΣFₙ₋₂, ΣFₙ₋₂}
Vⱼ_{_{—}}_{lib}: {ΣF′₁₋₁, ΣF′₁₋₂, ΣF′₂₋₁, ΣF′₂₋₂, ΣF′₃₋₁, . . . ΣF′ₖ₋₁, ΣF′ₖ₋₂, . . . ΣF′ₙ₋₂, ΣF′ₙ₋₂}
Vᵢ_{_{—}}_{lib}⊕Vⱼ_{_{—}}_{lib}: {ΣF₁₋₁⊕ΣF′₁₋₁, ΣF₁₋₂⊕ΣF′₂₋₂, . . . , ΣFₖ₋₁⊕ΣF′ₖ₋₁, ΣFₖ₋₂⊕ΣF′ₖ₋₂, . . . , ΣFₙ₋₁⊕ΣF′ₙ₋₁, ΣFₙ₋₂⊕ΣF′ₙ₋₂}
   wherein

Vᵢ_{_{—}}_{lib}: and Vⱼ_{_{—}}_{lib} are expanded vector representations for combinatorial library i and j.

Compared to expanded vector representation for a single gene, there might be more than one corresponding parsed oligonucleotides. Σ is used to represent 1 or more.
ΣFₖ₋ₕ⊕ΣGₖ₋ₕ=0, when any half-oligonucleotide is the same among the two set of half-oligonucleotides (where 1<=k<=n, and h=1 or h=2); otherwise, ΣFₖ₋ₕ⊕ΣGₖ₋ₕ=1, when all half-oligonculeotides have different sequence at this position. Likewise, if the resultant vector contains only one strips of “1”s, the two combinatorial libraries can be co-assembled.

Exemplary combinatorial libraries are named E_{—}1, E_{—}2 and E_{—}3, identified using methods described above. The expanded vector representation for each library is:

V_{E}_{_{—}}₁: {1,1,1,[1,2],1,1,1,[1,2],1,1}

V_{E}_{_{—}}₂: {1,1,1,3,1,[2,3],2,3,1,1}

V_{E}_{_{—}}₃: {1,1,1,3,2,4,3,[4,5],1,1}

The results for the XOR operations are:

V_{E}_{_{—}}₁⊕V_{E}_{_{—}}₂={0,0,0,1,0,1,1,1,0,0}=>0

V_{E}_{_{—}}₁⊕V_{E}_{_{—}}₃={0,0,0,1,1,1,1,1,0,0}=>1

V_{E}_{_{—}}₂⊕V_{E}_{_{—}}₃={0,0,0,0,1,1,1,1,0,0}=>1

E_{—}1 is a combinatorial library consisting of 4 polynucleotides, while E_{—}2 and E_{—}3 are combinatorial libraries with each having 2 members. Both E_{—}1 and E_{—}2 can be co-assembled with E_{—}3, but E_{—}1 and E_{—}2 cannot be co-assembled. In the co-assembly matrix, if two combinatorial libraries can be co-assembled, their corresponding matrix cell value is 1, otherwise, 0. Table 1 shows an exemplary co-assembly matrix for five combinatorial libraries.

TABLE 1

| Matrix | E_1 | E_2 | E_3 | E_4 | E_5 |
|---|---|---|---|---|---|
| E_1 | 1 | 0 | 1 | 1 | 1 |
| E_2 | 0 | 1 | 1 | 1 | 1 |
| E_3 | 1 | 1 | 1 | 1 | 0 |
| E_4 | 1 | 1 | 1 | 1 | 0 |
| E_5 | 1 | 1 | 0 | 0 | 1 |

TABLE 2
Two co-assembly sets identified from co-
assembly matrix in Table 1

| Matrix | E_1 | E_3 | E_4 | E_2 | E_5 |
|---|---|---|---|---|---|
| E_1 | 1 | 1 | 1 | 0 | 1 |
| E_3 | 1 | 1 | 1 | 1 | 0 |
| E_4 | 1 | 1 | 1 | 1 | 0 |
| E_2 | 0 | 1 | 1 | 1 | 1 |
| E_5 | 1 | 0 | 0 | 1 | 1 |

ALGORITHM2 shows a method to identify combinatorial libraries that can be co-assembled:

Variables used in the algorithm are:
coSets: all the co-assembly sets
coSubSet: one co-assembly set
coList: the candidate list entities that can be co-assembled with the current seed entity
gList: the list of entities
E1, E2, . . . , En: each individual combinatorial library

### Pseudocode for Identification of all Co-Assembly Sets:

```
Add each combinatorial library E1, E2, ..., En to gList
Initialize coSets to empty;
#Repeat until all libraries assigned to a co-assembly set
While (gList is not empty) {
  Take the 1^{ST} entity Eᵢ in gList as the seed entity;
  Initialize coList to empty;
  Initialize coSubSet to an empty;
  Add Eᵢ to coSubSet;
  #add potential libraries co-assembled with Eᵢ to coList
  Foreach Eⱼ from gList {
    if ( coAssembleMatrixCell(Eᵢ , Eⱼ) == true) {Add Eⱼ to
    coList}
  }
    #check each potential entity and add them to co-assembly
      set
    do {
            Remove Eₖ from coList, add Eₖ to coSubSet;
            #Entity not qualified for co-assembly removed from
coList
            foreach Ec in coList {
                if ( coAssembleMatrix(Eₖ , E_{c}) == false ) {
                  remove E_{C} from coList;
                }
            }
    } while ( coList is not empty? )
    #add this co-assembly set to coSets
    Add coSubSet to coSets
    #Remove all entities in coSubSet from gList
    foreach Ee in coSubSet {
        remove Ee from gList
    }
  }
  Output each co-assembly coSubSet in coSets
```

An integrated software package for co-assembly has been developed and implemented using Java and Java Swing. The package automatically 1) reads in a sequence library and identifies unique oligos to be synthesized; 2) generates both simple and expanded vector representations for each gene; 3) calculates the oligo sibling matrix, and identifies combinatorial library of sequences starting from a seed sequence; 4) calculates the co-assembly matrix and identifies all co-assembly sets; and 5) writes out each co-assembly set for gene synthesis/assembly directly.

### Example 1

### Co-Assembly of Tenascin Fibronectin Fomain (FN3) Variants

Tenascin 3^{rd} fibronectin domain (FN3) is representative of a class of Ig-like scaffolds that incorporates CDR-like loops extending from the surface of the molecule, and has been widely used for identification of binding proteins to modulate activity of therapeutic proteins (Lipovsek et al., Antibodies J. Mol. Biol. 368: 1024-41, 2007).

A 144 base pair fragment was identified in the 3^{rd} FN3 loop of human Tenascin (nucleotides 2862-3002 in human Tenascin, Gen Bank Acc. No. NM_{—}002160, SEQ ID NO: 13), and a library of variants were designed and assembled to validate the co-assembly algorithm. Table 3 shows the sequence of the Tenascin gene fragment used. The library of variants will be designed by introducing amino acid change at underlined codon positions shown in Table 3. A total of 12 sequences are designed. Their corresponding parsed oligonucleotdies (both forward and reverse) are shown in Table 4.

TABLE 3

| | | |
|---|---|---|
| | Restriction site | |
| 1 | GAACTCACGTACGGTATTAAAGACGTCCCGGGCGATCGCACCACCATA | 48 |
| 49 | GATCTGACCGAAGATGAAAACCAGTATTCAATTGGTAACCTTAAGCCG | 96 |
| 97 | GATACCGAATATGAAGTAAGCTTGATCTCGCGCCGCGGCGATATGGGC | 144 |
| | Restriction site | |

For any variant, the same residue is introduced at each codon position (underlined in Table 3). The sequences are denoted as A,E,L,M,N,P,R,S,T,V,W,Y according to the introduced amino acid, respectively.

### Results:

1. ALGORITHM 1: e.g. variants that form a combinatorial library
2. ALGORITHM 2 e.g. variants/libraries that can be co-assembled.
   Pool all the F1/F2/F3/R1/R2 (12 each) and S1/S2 oligos together, and then assemble, clone, and sequence the library. All 12 genes will be obtained by one co-assembly process. Otherwise, 12 separate syntheses are needed if traditional gene synthesis approach is used. Designed library variants are shown in SEQ ID NOs: 1-12.

TABLE 4

| | |
|---|---|
| R3 | GTCTTTAATACCGTACGTGAGTTC |
| R4 | GCCCATATCGCCGCGGCGCGAGAT |
| A_F1 | GAACTCACGTACGGTATTAAAGACGTCCCGGGCGATGCCACCACCATA |
| E_F1 | ....................................GAG......... |
| L_F1 | ....................................TTA......... |
| M_F1 | ....................................ATG......... |
| N_F1 | ....................................AAC......... |
| P_F1 | ....................................CCG......... |
| R_F1 | ....................................CGA......... |
| S_F1 | ....................................AGT......... |
| T_F1 | ....................................ACA......... |
| V_F1 | ....................................GTT......... |
| W_F1 | ....................................TGG......... |
| Y_F1 | ....................................TAT......... |
| A_F2 | GATCTGACCGAAGCCGAAAACCAGTATTCAATTGGTGCCCTTAAGCCG |
| E_F2 | ............GAG.....................GAG......... |
| L_F2 | ............TTA.....................TTA......... |
| M_F2 | ............ATG.....................ATG......... |
| N_F2 | ............AAC.....................AAC......... |
| P_F2 | ............CCG.....................CCG......... |
| R_F2 | ............CGA.....................CGA......... |
| S_F2 | ............AGT.....................AGT......... |
| T_F2 | ............ACA.....................ACA......... |
| V_F2 | ............GTT.....................GTT......... |
| W_F2 | ............TGG.....................TGG......... |
| Y_F2 | ............TAT.....................TAT......... |
| A_F3 | GATACCGAATATGCCGTAAGCTTGATCTCGCGCCGCGGCGATATGGGC |
| E_F3 | ............GAG................................. |
| L_F3 | ............TTA................................. |
| M_F3 | ............ATG................................. |
| N_F3 | ............AAC................................. |
| P_F3 | ............CCG................................. |
| R_F3 | ............CGA................................. |
| S_F3 | ............AGT................................. |
| T_F3 | ............ACA................................. |
| V_F3 | ............GTT................................. |
| W_F3 | ............TGG................................. |
| Y_F3 | ............TAT................................. |
| A_R1 | CTGGTTTTCGGCTTCGGTCAGATCTATGGTGGTGGCATCGCCCGGGAC |
| E_R1 | .........CTC.....................CTC............ |
| L_R1 | .........TAA.....................TAA............ |
| M_R1 | .........CAT.....................CAT............ |
| N_R1 | .........GTT.....................GTT............ |
| P_R1 | .........CGG.....................CGG............ |
| R_R1 | .........TCG.....................TCG............ |
| S_R1 | .........ACT.....................ACT............ |
| T_R1 | .........TGT.....................TGT............ |
| V_R1 | .........AAC.....................AAC............ |
| W_R1 | .........CCA.....................CCA............ |
| Y_R1 | .........ATA.....................ATA............ |
| A_R2 | CAAGCTTACGGCATATTCGGTATCCGGCTTAAGGGCACCAATTGAATA |
| E_R2 | .........CTC.....................CTC............ |
| L_R2 | .........TAA.....................TAA............ |
| M_R2 | .........CAT.....................CAT............ |
| N_R2 | .........GTT.....................GTT............ |
| P_R2 | .........CGG.....................CGG............ |
| R_R2 | .........TCG.....................TCG............ |
| S_R2 | .........ACT.....................ACT............ |
| T_R2 | .........TGT.....................TGT............ |
| V_R2 | .........AAC.....................AAC............ |
| W_R2 | .........CCA.....................CCA............ |
| Y_R2 | .........ATA.....................ATA............ |

We claim:

1. A method of identifying a combinatorial library of polynucleotide variants, comprising:
a. providing a collection of polynucleotide variants;
b. obtaining sequences of the polynucleotide variants;
c. parsing the polynucleotide variants into contiguous parsed oligonucleotides;
d. adding a first polynucleotide variant from the collection of polynucleotide variants into the combinatorial library;
e. comparing corresponding parsed oligonucleotides in the first polynucleotide variant and the collection of polynucleotide variants;
f. adding those polynucleotide variants from the collection of polynucleotide variants into an analyzed pool of polynucleotide variants that differ at only one corresponding parsed oligonucleotide from the first polynucleotide variant;
g. adding a second polynucleotide variant from the analyzed pool of polynucleotide variants into the combinatorial library;
h. comparing corresponding parsed oligonucleotides in the second polynucleotide variant and the collection of polynucleotide variants;
i. adding those polynucleotide variants from the collection of polynucleotide variants into the analyzed pool of polynucleotide variants that differ at only one corresponding parsed oligonucleotide from the second polynucleotide variant; and
j. repeating steps g-i until the analyzed pool of polynucleotide variants is empty.

2. A method of synthesizing a combinatorial library of polynucleotide variants, comprising:
a. providing a collection of polynucleotide variants;
b. obtaining sequences of the polynucleotide variants;
c. parsing the polynucleotide variants into contiguous parsed oligonucleotides;
d. adding a first polynucleotide variant from the collection of polynucleotide variants into the combinatorial library;
e. comparing corresponding parsed oligonucleotides in the first polynucleotide variant and the collection of polynucleotide variants;
f. adding those polynucleotide variants from the collection of polynucleotide variants into an analyzed pool of polynucleotide variants that differ at only one corresponding parsed oligonucleotide from the first polynucleotide variant;
g. adding a second polynucleotide variant from the analyzed pool of polynucleotide variants into the combinatorial library;
h. comparing corresponding parsed oligonucleotides in the second polynucleotide variant and the collection of polynucleotide variants;
i. adding those polynucleotide variants from the collection of polynucleotide variants into the analyzed pool of polynucleotide variants that differ at only one corresponding parsed oligonucleotide from the second polynucleotide variant;
j. repeating steps g-i until the analyzed pool of polynucleotide variants is empty, and
k. synthesizing the combinatorial library of polynucleotide variants using synthetic polynucleotide assembly.

3. A method of selecting combinatorial libraries that can form a co-assembly set, comprising:
a. identifying a first and a second combinatorial library according to methods of the invention;
b. parsing each sequence in the first and the second combinatorial library into contiguous oligonucleotides;
c. comparing a first pool of corresponding parsed oligonucleotides in the first library and a second pool of corresponding parsed oligonucleotides in the second library; and
d. selecting the first and the second combinatorial library when the first pool of corresponding parsed oligonucleotides and the second pool of corresponding parsed oligonucleotides share zero identical sequences at one or more adjacent corresponding fragments.

4. The method of claim 3, wherein the first and the second combinatorial library comprises one polynucleotide variant each.

5. The method of claim 2 or 3 wherein the fragments are between 16-32 nucleotides long.

6. The method of claim 2 or 3 wherein the fragments are at least 16 nucleotides long.

7. The method of claim 2 or 3 wherein the fragments are 24 nucleotides long.


SEQUENCE LISTING (13 sequences)

SEQ ID NO: 1 - DNA, 144 bp, Artificial Sequence
  Tenascin Fn domain variant L
gaactcacgtacggtattaaagacgtcccgggcgatttaaccaccatagatctgaccgaattagaaaaccagtattcaattggtttacttaagccggataccgaatatttagtaagcttgatctcgcgccgcggcgatatgggc

SEQ ID NO: 2 - DNA, 144 bp, Artificial Sequence
  Tenascin Fn domain variant M
gaactcacgtacggtattaaagacgtcccgggcgatatgaccaccatagatctgaccgaaatggaaaaccagtattcaattggtatgcttaagccggataccgaatatatggtaagcttgatctcgcgccgcggcgatatgggc

SEQ ID NO: 3 - DNA, 144 bp, Artificial Sequence
  Tenascin Fn domain variant N
gaactcacgtacggtattaaagacgtcccgggcgataacaccaccatagatctgaccgaaaacgaaaaccagtattcaattggtaaccttaagccggataccgaatataacgtaagcttgatctcgcgccgcggcgatatgggc

SEQ ID NO: 4 - DNA, 144 bp, Artificial Sequence
  Tenascin Fn domain variant P
gaactcacgtacggtattaaagacgtcccgggcgatccgaccaccatagatctgaccgaaccggaaaaccagtattcaattggtccgcttaagccggataccgaatatccggtaagcttgatctcgcgccgcggcgatatgggc

SEQ ID NO: 5 - DNA, 144 bp, Artificial Sequence
  Tenascin Fn domain variant R
gaactcacgtacggtattaaagacgtcccgggcgatcgaaccaccatagatctgaccgaacgagaaaaccagtattcaattggtcgacttaagccggataccgaatatcgagtaagcttgatctcgcgccgcggcgatatgggc

SEQ ID NO: 6 - DNA, 144 bp, Artificial Sequence
  Tenascin Fn domain variant S
gaactcacgtacggtattaaagacgtcccgggcgatagtaccaccatagatctgaccgaaagtgaaaaccagtattcaattggtagtcttaagccggataccgaatatagtgtaagcttgatctcgcgccgcggcgatatgggc

SEQ ID NO: 7 - DNA, 144 bp, Artificial Sequence
  Tenascin Fn domain variant T
gaactcacgtacggtattaaagacgtcccgggcgatacaaccaccatagatctgaccgaaacagaaaaccagtattcaattggtacacttaagccggataccgaatatacagtaagcttgatctcgcgccgcggcgatatgggc

SEQ ID NO: 8 - DNA, 144 bp, Artificial Sequence
  Tenascin Fn domain variant V
gaactcacgtacggtattaaagacgtcccgggcgatgttaccaccatagatctgaccgaagttgaaaaccagtattcaattggtgttcttaagccggataccgaatatgttgtaagcttgatctcgcgccgcggcgatatgggc

SEQ ID NO: 9 - DNA, 144 bp, Artificial Sequence
  Tenascin Fn domain variant W
gaactcacgtacggtattaaagacgtcccgggcgattggaccaccatagatctgaccgaatgggaaaaccagtattcaattggttggcttaagccggataccgaatattgggtaagcttgatctcgcgccgcggcgatatgggc

SEQ ID NO: 10 - DNA, 144 bp, Artificial Sequence
  Tenascin Fn domain variant Y
gaactcacgtacggtattaaagacgtcccgggcgattataccaccatagatctgaccgaatatgaaaaccagtattcaattggttatcttaagccggataccgaatattatgtaagcttgatctcgcgccgcggcgatatgggc

SEQ ID NO: 11 - DNA, 144 bp, Artificial Sequence
  Tenascin Fn domain variant A
gaactcacgtacggtattaaagacgtcccgggcgatgccaccaccatagatctgaccgaagccgaaaaccagtattcaattggtgcccttaagccggataccgaatatgccgtaagcttgatctcgcgccgcggcgatatgggc

SEQ ID NO: 12 - DNA, 144 bp, Artificial Sequence
  Tenascin Fn domain variant E
gaactcacgtacggtattaaagacgtcccgggcgatgagaccaccatagatctgaccgaagaggaaaaccagtattcaattggtgagcttaagccggataccgaatatgaggtaagcttgatctcgcgccgcggcgatatgggc

SEQ ID NO: 13 - DNA, 7616 bp, Homo sapiens
attacagaggaaggagctcgctatataagccagccaaagttggctgcaccggccacagcctgcctactgtcacccgcctctcccgcgcgcagatacacgcccccgcctccgtgggcacaaaggcagcgctgctggggaactcgggggaacgcgcacgtgggaaccgccgcagctccacactccaggtacttcttccaaggacctaggtctctcgcccatcggaaagaaaataattctttcaagaagatcagggacaactgatttgaagtctactctgtgcttctaaatccccaattctgctgaaagtgagataccctagagccctagagccccagcagcacccagccaaacccacctccaccatgggggccatgactcagctgttggcaggtgtctttcttgctttccttgccctcgctaccgaaggtggggtcctcaagaaagtcatccggcacaagcgacagagtggggtgaacgccaccctgccagaagagaaccagccagtggtgtttaaccacgtttacaacatcaagctgccagtgggatcccagtgttcggtggatctggagtcagccagtggggagaaagacctggcaccgccttcagagcccagcgaaagctttcaggagcacacagtggatggggaaaaccagattgtcttcacacatcgcatcaacatcccccgccgggcctgtggctgtgccgcagcccctgatgttaaggagctgctgagcagactggaggagctggagaacctggtgtcttccctgagggagcaatgtactgcaggagcaggctgctgtctccagcctgccacaggccgcttggacaccaggcccttctgtagcggtcggggcaacttcagcactgaaggatgtggctgtgtctgcgaacctggctggaaaggccccaactgctctgagcccgaatgtccaggcaactgtcaccttcgaggccggtgcattgatgggcagtgcatctgtgacgacggcttcacgggcgaggactgcagccagctggcttgccccagcgactgcaatgaccagggcaagtgcgtaaatggagtctgcatctgtttcgaaggctacgccggggctgactgcagccgtgaaatctgcccagtgccctgcagtgaggagcacggcacatgtgtagatggcttgtgtgtgtgccacgatggctttgcaggcgatgactgcaacaagcctctgtgtctcaacaattgctacaaccgtggacgatgcgtggagaatgagtgcgtgtgtgatgagggtttcacgggcgaagactgcagtgagctcatctgccccaatgactgcttcgaccggggccgctgcatcaatggcacctgctactgcgaagaaggcttcacaggtgaagactgcgggaaacccacctgcccacatgcctgccacacccagggccggtgtgaggaggggcagtgtgtatgtgatgagggctttgccggtgtggactgcagcgagaagaggtgtcctgctgactgtcacaatcgtggccgctgtgtagacgggcggtgtgagtgtgatgatggtttcactggagctgactgtggggagctcaagtgtcccaatggctgcagtggccatggccgctgtgtcaatgggcagtgtgtgtgtgatgagggctatactggggaggactgcagccagctacggtgccccaatgactgtcacagtcggggccgctgtgtcgagggcaaatgtgtatgtgagcaaggcttcaagggctatgactgcagtgacatgagctgccctaatgactgtcaccagcacggccgctgtgtgaatggcatgtgtgtttgtgatgacggctacacaggggaagactgccgggatcgccaatgccccagggactgcagcaacaggggcctctgtgtggacggacagtgcgtctgtgaggacggcttcaccggccctgactgtgcagaactctcctgtccaaatgactgccatggccagggtcgctgtgtgaatgggcagtgcgtgtgccatgaaggatttatgggcaaagactgcaaggagcaaagatgtcccagtgactgtcatggccagggccgctgcgtggacggccagtgcatctgccacgagggcttcacaggcctggactgtggccagcactcctgccccagtgactgcaacaacttaggacaatgcgtctcgggccgctgcatctgcaacgagggctacagcggagaagactgctcagaggtgtctcctcccaaagacctcgttgtgacagaagtgacggaagagacggtcaacctggcctgggacaatgagatgcgggtcacagagtaccttgtcgtgtacacgcccacccacgagggtggtctggaaatgcagttccgtgtgcctggggaccagacgtccaccatcatccaggagctggagcctggtgtggagtactttatccgtgtatttgccatcctggagaacaagaagagcattcctgtcagcgccagggtggccacgtacttacctgcacctgaaggcctgaaattcaagtccatcaaggagacatctgtggaagtggagtgggatcctctagacattgcttttgaaacctgggagatcatcttccggaatatgaataaagaagatgagggagagatcaccaaaagcctgaggaggccagagacctcttaccggcaaactggtctagctcctgggcaagagtatgagatatctctgcacatagtgaaaaacaatacccggggccctggcctgaagagggtgaccaccacacgcttggatgcccccagccagatcgaggtgaaagatgtcacagacaccactgccttgatcacctggttcaagcccctggctgagatcgatggcattgagctgacctacggcatcaaagacgtgccaggagaccgtaccaccatcgatctcacagaggacgagaaccagtactccatcgggaacctgaagcctgacactgagtacgaggtgtccctcatctcccgcagaggtgacatgtcaagcaacccagccaaagagaccttcacaacaggcctcgatgctcccaggaatcttcgacgtgtttcccagacagataacagcatcaccctggaatggaggaatggcaaggcagctattgacagttacagaattaagtatgcccccatctctggaggggaccacgctgaggttgatgttccaaagagccaacaagccacaaccaaaaccacactcacaggtctgaggccgggaactgaatatgggattggagtttctgctgtgaaggaagacaaggagagcaatccagcgaccatcaacgcagccacagagttggacacgcccaaggaccttcaggtttctgaaactgcagagaccagcctgaccctgctctggaagacaccgttggccaaatttgaccgctaccgcctcaattacagtctccccacaggccagtgggtgggagtgcagcttccaagaaacaccacttcctatgtcctgagaggcctggaaccaggacaggagtacaatgtcctcctgacagccgagaaaggcagacacaagagcaagcccgcacgtgtgaaggcatccactgaacaagcccctgagctggaaaacctcaccgtgactgaggttggctgggatggcctcagactcaactggaccgcagctgaccaggcctatgagcactttatcattcaggtgcaggaggccaacaaggtggaggcagctcggaacctcaccgtgcctggcagccttcgggctgtggacataccgggcctcaaggctgctacgccttatacagtctccatctatggggtgatccagggctatagaacaccagtgctctctgctgaggcctccacaggggaaactcccaatttgggagaggtcgtggtggccgaggtgggctgggatgccctcaaactcaactggactgctccagaaggggcctatgagtactttttcattcaggtgcaggaggctgacacagtagaggcagcccagaacctcaccgtcccaggaggactgaggtccacagacctgcctgggctcaaagcagccactcattataccatcaccatccgcggggtcactcaggacttcagcacaacccctctctctgttgaagtcttgacagaggaggttccagatatgggaaacctcacagtgaccgaggttagctgggatgctctcagactgaactggaccacgccagatggaacctatgaccagtttactattcaggtccaggaggctgaccaggtggaagaggctcacaatctcacggttcctggcagcctgcgttccatggaaatcccaggcctcagggctggcactccttacacagtcaccctgcacggcgaggtcaggggccacagcactcgaccccttgctgtagaggtcgtcacagaggatctcccacagctgggagatttagccgtgtctgaggttggctgggatggcctcagactcaactggaccgcagctgacaatgcctatgagcactttgtcattcaggtgcaggaggtcaacaaagtggaggcagcccagaacctcacgttgcctggcagcctcagggctgtggacatcccgggcctcgaggctgccacgccttatagagtctccatctatggggtgatccggggctatagaacaccagtactctctgctgaggcctccacagccaaagaacctgaaattggaaacttaaatgtttctgacataactcccgagagcttcaatctctcctggatggctaccgatgggatcttcgagacctttaccattgaaattattgattccaataggttgctggagactgtggaatataatatctctggtgctgaacgaactgcccatatctcagggctaccccctagtactgattttattgtctacctctctggacttgctcccagcatccggaccaaaaccatcagtgccacagccacgacagaggccctgccccttctggaaaacctaaccatttccgacattaatccctacgggttcacagtttcctggatggcatcggagaatgcctttgacagctttctagtaacggtggtggattctgggaagctgctggacccccaggaattcacactttcaggaacccagaggaagctggagcttagaggcctcataactggcattggctatgaggttatggtctctggcttcacccaagggcatcaaaccaagcccttgagggctgagattgttacagaagccgaaccggaagttgacaaccttctggtttcagatgccaccccagacggtttccgtctgtcctggacagctgatgaaggggtcttcgacaattttgttctcaaaatcagagataccaaaaagcagtctgagccactggaaataaccctacttgcccccgaacgtaccagggacataacaggtctcagagaggctactgaatacgaaattgaactctatggaataagcaaaggaaggcgatcccagacagtcagtgctatagcaacaacagccatgggctccccaaaggaagtcattttctcagacatcactgaaaattcggctactgtcagctggagggcacccacagcccaagtggagagcttccggattacctatgtgcccattacaggaggtacaccctccatggtaactgtggacggaaccaagactcagaccaggctggtgaaactcatacctggcgtggagtaccttgtcagcatcatcgccatgaagggctttgaggaaagtgaacctgtctcagggtcattcaccacagctctggatggcccatctggcctggtgacagccaacatcactgactcagaagccttggccaggtggcagccagccattgccactgtggacagttatgtcatctcctacacaggcgagaaagtgccagaaattacacgcacggtgtccgggaacacagtggagtatgctctgaccgacctcgagcctgccacggaatacacactgagaatctttgcagagaaagggccccagaagagctcaaccatcactgccaagttcacaacagacctcgattctccaagagacttgactgctactgaggttcagtcggaaactgccctccttacctggcgacccccccgggcatcagtcaccggttacctgctggtctatgaatcagtggatggcacagtcaaggaagtcattgtgggtccagataccacctcctacagcctggcagacctgagcccatccacccactacacagccaagatccaggcactcaatgggcccctgaggagcaatatgatccagaccatcttcaccacaattggactcctgtaccccttccccaaggactgctcccaagcaatgctgaatggagacacgacctctggcctctacaccatttatctgaatggtgataaggctgaggcgctggaagtcttctgtgacatgacctctgatgggggtggatggattgtgttcctgagacgcaaaaacggacgcgagaacttctaccaaaactggaaggcatatgctgctggatttggggaccgcagagaagaattctggcttgggctggacaacctgaacaaaatcacagcccaggggcagtacgagctccgggtggacctgcgggaccatggggagacagcctttgctgtctatgacaagttcagcgtgggagatgccaagactcgctacaagctgaaggtggaggggtacagtgggacagcaggtgactccatggcctaccacaatggcagatccttctccacctttgacaaggacacagattcagccatcaccaactgtgctctgtcctacaaaggggctttctggtacaggaactgtcaccgtgtcaacctgatggggagatatggggacaataaccacagtcagggcgttaactggttccactggaagggccacgaacactcaatccagtttgctgagatgaagctgagaccaagcaacttcagaaatcttgaaggcaggcgcaaacgggcataaattccagggaccactgggtgagagaggaataaggcccagagcgaggaaaggattttaccaaagcatcaatacaaccagcccaaccatcggtccacacctgggcatttggtgagagtcaaagctgaccatggatccctggggccaacggcaacagcatgggcctcacctcctctgtgatttctttctttgcaccaaagacatcagtctccaacatgtttctgttttgttgtttgattcagcaaaaatctcccagtgacaacatcgcaatagttttttacttctcttaggtggctctgggaatgggagaggggtaggatgtacaggggtagtttgttttagaaccagccgtattttacatgaagctgtataattaattgtcattatttttgttagcaaagattaaatgtgtcattggaagccatccctttttttacatttcatacaacagaaaccagaaaagcaatactgtttccattttaaggatatgattaatattattaatataataatgatgatgatgatgatgaaaactaaggatttttcaagagatctttctttccaaaacatttctggacagtacctgattgtattttttttttaaataaaagcacaagtacttttgagtttgttaaaaaaaaaaaaaaaaaa